(19) United States
(12) Patent Application Publication
(10) Pub. No.: US 2017/0025905 A1
(43) Pub. Date: Jan. 26, 2017

(54) Method of automatic charging

(71) Applicants: Zhengmin Benjamin Pan, L.A., CA (US); Xiaoyu Zhang, Shenzhen (CN)

(72) Inventors: Zhengmin Benjamin Pan, L.A., CA (US); Xiaoyu Zhang, Shenzhen (CN)

(73) Assignee: AAC Technologies Pte. Ltd., Singapore city (SG)

(21) Appl. No.: 15/011,596

(22) Filed: Jan. 31, 2016

(30) Foreign Application Priority Data
Jun. 10, 2015 (CN) 201510317559.1

(51) Int. Cl. H02J 50/90; H02J 50/60; H02J 7/02; H02J 50/10; H04B 5/00; H02J 7/00

(52) U.S. Cl. CPC H02J 50/90; H04B 5/0037; H02J 7/0052; H02J 7/0047; H02J 7/025; H02J 50/10; H02J 50/60

(57) ABSTRACT

A method of realizing low battery fully automatic charging in communication equipment, includes the following steps: a) Providing a quantity of electricity detector, when quantity of electricity detector detects that the quantity of electricity of mobile communication equipment is lower than set threshold, step (b) should be started; b) the said mobile communication equipment searching and positioning one external charging device to positioning the coordinates of mobile communication equipment by taking the position where the external charging device is placed as the origin of coordinates; c) Starting the mobile communication terminal to move towards the direction of the external charging device; d) providing an interface set on the mobile communication equipment. Charging of mobile communication equipment is realized through the matching of interface and external charging device.

### FIELD OF THE INVENTION

The invention is related to one kind of mobile communication equipment with the function of low battery charging and the method of automatic low battery charging.

### DESCRIPTION OF RELATED ART

With the arrival of mobile internet age, the quantity of intelligent mobile equipment is rising continuously, such as cell phone, tablet PC etc. At present, the function of mobile communication equipment is diverse. People's demands on mobile communication equipment is that it should not only have the communication function and but also more functions to meet people's demands, such as power consumption of nowadays mobile communication equipment is large, it needs to be charged frequently, so user must pay close attention to service condition of quantity of electricity at any moment, connect and charge, in this way the use of product is influenced, so one kind of mobile communication equipment that can solve the above problems is needed urgently.

### BRIEF DESCRIPTION OF THE DRAWINGS

Many aspects of the embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a mobile communication equipment of the invention, showing the working principle of the equipment.

FIG. 2 is a schematic diagram of the mobile communication equipment of the invention.

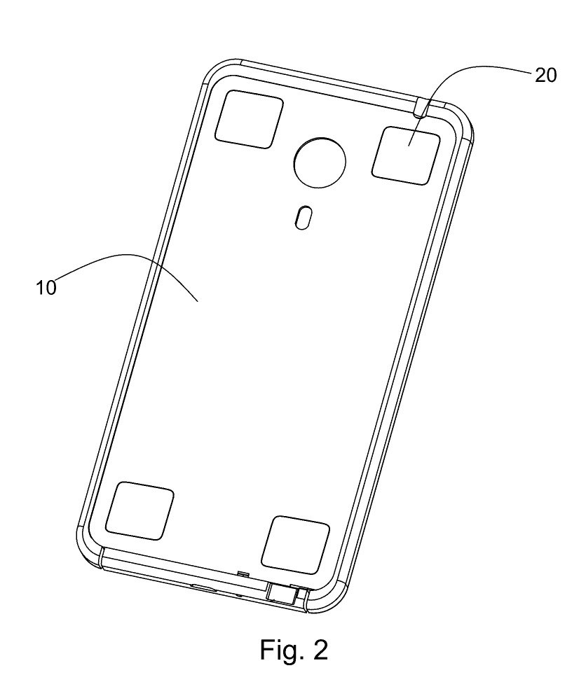

FIG. 3 is the schematic diagram of the mobile communication equipment of the invention in the moving state.

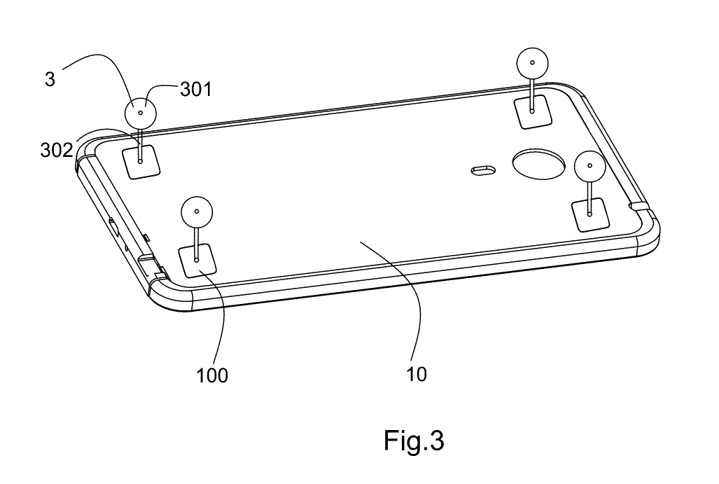

### DETAILED DESCRIPTION OF THE EXEMPLARY EMBODIMENT

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

The invention provides one method of realizing low battery auto charging in mobile communication device. It includes concretely the following steps: a) provide a quantity of electricity detector. When the quantity of electricity detector detects that the quantity of electricity of mobile communication equipment is lower than one set threshold, charging preparation mode should be started. b) In the charging preparation mode, mobile communication equipment communicates with the external charging device. The mobile communication device searches and positions one external charging device and positions the coordinates of mobile communication equipment by taking the position that the external charging equipment is placed. c.) Start mobile equipment to move towards the direction of the external charging device under the processing of processor. d) One interface is set on mobile communication equipment. The mobile communication equipment is charged through the matching of interface with external charging device.

Among the above-mentioned step b), two positioning devices being apart at specific distance are set respectively on the mobile communication equipment. Two positioning devices send or receive respectively a detection signal that can recognize angle to record two angles respectively and calculate the distance that mobile communication equipment opposite to external charging device according to the distance between angle and two positioning devices. The coordinate of mobile communication equipment is confirmed by using the location that external charging device is placed as the origin of coordinates.

Among the above-mentioned step C, the mobile communication equipment can be moved by setting roller wheel, spiral rotor or jet.

The interface in the above step d.) can be tail plug used for mobile communication equipment and is charged through connecting with external connector physically. It can be NFC charging coil enclosed in the housing. The wireless charging panel with the electromagnetic induction principle set outside is charged by adopting electromagnetic induction method.

The above-mentioned method can make mobile communication equipment to possess the function of charging automatically under low battery to prevent the interruption of communication and other harmful effects to mobile communication equipment due to sudden power failure.

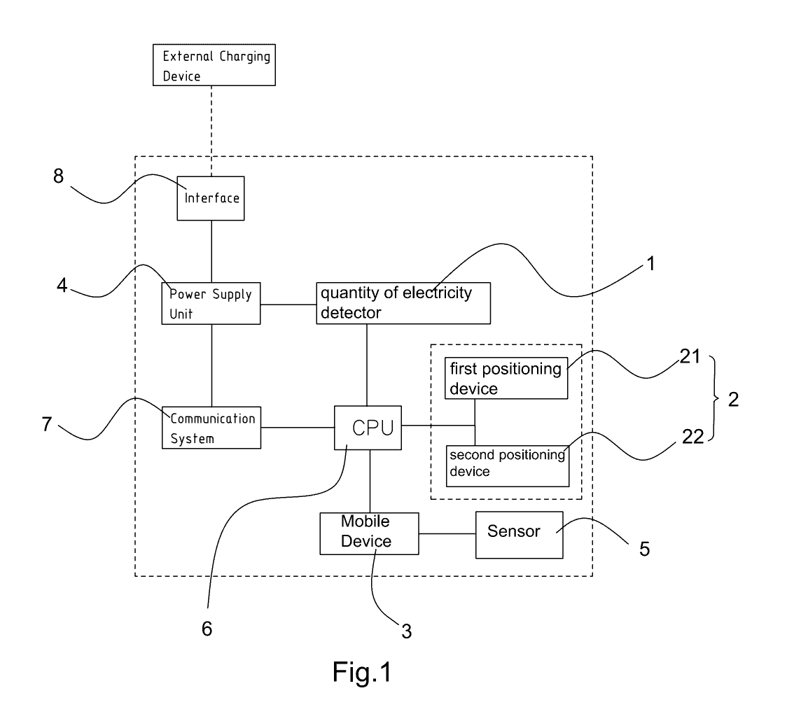

As shown in FIG. 1, the mobile communication equipment provided for the invention used for realizing the above-mentioned fully automatic charging function can concretely be one intelligent cell phone, which includes a housing 10 with internal receiving space, the mainboard received in the housing 10, the communication system 7, the CPU processor 6 set on the mainboard, the power supply unit 4 set on the mobile communication equipment used for supplying power to mobile communication equipment overally, received in the housing 10 and connected with the electrically. In the mode of execution, power supply unit is lithium battery. Of course, in other optional mode of executions, it can be battery of other types or power supply unit of other forms.

When it is used, user presets one specific quantity value of electricity. When quantity of electricity detector 1 detects that quantity of electricity is lower than the threshold value, processor 6 will process and control to start charging preparation mode.

Mobile communication equipment includes further the quantity of electricity detector 1 used for detecting the quantity of electricity of power supply unit 4. The quantity of electricity detector 1 exchanges data with the processor 6 and outputs the detected detection results of quantity of electricity of power supply unit 4 to processor 6. The mobile communication equipment has normal usage mode, charging ready mode and charging mode etc modes.

Mobile communication equipment further includes positioning device 2 which will exchange data with external charging unit, positioning the position that external charging device is placed and calculate the distance away from external charging unit. In the mode of execution, the positioning device 2 includes the first positioning device 21 and the second positioning device 22 set respectively on the housing. The first positioning device 21 and the second positioning device 22 are apart at specific distance. When mobile communication equipment enters charging preparation mode, the first positioning device 21 and the second positioning device 22 send or receive respectively one detection signal that can recognize angle. Correspondingly, the detection signal is received or sent by the device set on external charging device, namely the detection signal is transmitted rectilinearly among external charging device, the first positioning device 21 and the second positioning device 22. The scope of the signal sent by the first positioning device 21 and the second positioning device 22 is overlapped. As the first positioning device 21 and the second positioning device 22 are set in different positions of mobile communication equipment respectively, the angle of the first signal sent by the first positioning device 21 and the angle of the second signal sent by the second positioning device 22 are not necessarily same. The positioning device 2 records two angles respectively and calculates the distance of mobile communication equipment opposite to external charging device according to distance of the angle to two positioning devices and confirms the coordinates of mobile communication equipment by taking the position that external charging device as the origin of coordinates. In the mode of execution, the housing of the mobile communication equipment is long-strip, including two long axis sides and two short axis sides. The vertex angle connecting two sides is set between adjacent long axis side and short axis side. The vertex angle can be right angle and arc excessive fillet, other arc excessive for beautiful appearance setting, all are implemented. The first positioning device 21 and the second positioning device 22 are located respectively on two nonadjacent vertex angles of mobile communication equipment. At this time, the distance between two positioning devices is the length of diagonal of mobile communication equipment, in this way, it can guarantee that distance between the first positioning device 21 and the second positioning device 22 is maximum and the precision of positioning device can be improved.

Mobile communication equipment further includes mobile device 3 that is received in the housing when it is in normal operating mode. It will start after entering charging ready mode. The mobile device 3 includes telescopic control device 302 and mobile driving device 301 specifically. The telescopic control device 302 is connected with processor 6 to control mobile driving device 302 to contract or extend. Receiving groove 100 is set on the housing 10 to be used for receiving fixed mobile device. Furtherly, one openable window 20 is set on housing. The window 20 is covered on receiving groove 100 and forms receiving with receiving groove 100 together to form the space that can receive mobile device. The openable window 20 is connected with telescopic control device 302. When it enters charging preparation mode, processor 6 sends telescopic signal, the telescopic control device 302 will control window 20 to start to expose receiving groove 100 and mobile driving device extend to the outside of housing 10. Telescopic control device 302 can control simple mechanical drive and can connect mobile driving device and window electrically and output signal to control window and move driving device respectively to realize the function.

The mobile driving device can be roller-wheel equipment or spiral flight unit or jet flying device. Their working modes are approximately the same. When it is flying device, the mobile driving device of mobile communication equipment is a number of spiral rotors or air-jet devices and is received in the housing usually. After starting airplane mode, it extends and turns or jets to provide suspension force to make mobile communication equipment to fly to external charging device and fall. Further, in the mode of execution, the mobile communication equipment has the start up and landing buffer mechanism and can be jet mechanism, physical mode such as spring air cushion etc. Spring or air cushion is received in housing. When mobile communication equipment starts flying or lowers, it is popped up to contact the outside firstly to play the role of cushion. When it is roller-wheel mechanism, it is moved to external charging device through roller wheel. Optimally, in order to have telescopic control device to control, the telescopic roller-wheel can be telescopic universal roller-wheel.

Concretely, in the mode of execution, there are four mobile driving devices totally which are located on four corners of mobile communication equipment respectively. In this way, it can make mobile communication equipment more stable during the process of movement. There are four ones on the corresponding openable window 20 which are located on the relative position of moving driving device of four corners of housing.

Further, sensor 5 is set on the mobile communication equipment and used for sensing barrier during the process of movement and transmitting the sensed result of barrier to processor 6 to avoid barrier through the control of processor 6. Concretely, there are one or more infrared sensors set on the sides of housing respectively.

Interface 8 used for connecting electrically with power supply unit 4 is set on the housing 10 further. When the mobile communication equipment moves to position of the external charging unit, interface 8 matches the external charging device to enter charging mode and realizes the charging of mobile communication equipment. The interface can be traditional physical interface, such as tail plug etc and other forms. In the mode of execution, it is NFC charge coil enclosed inside the housing. Correspondingly, NFC induction coil is adopted for external charging equipment. Near field communication ways is adopted for mobile communication equipment and external charging unit. Electromagnetic induction is generated between two coils to realize the charging of mobile communication equipment. In this way, the interface of mobile communication equipment can match external communication equipment easily and lower the precision of positioning device and mobile device and reduce the damage caused by the plugging and unplugging of traditional physical interface.

External charging equipment can be fixed at certain position and mobile too. It can be implemented and optimized only if the device that can receive or send signal is set. Preferably, the external charging device is fixed, such as indoor fixed socket or the charging board of electromagnetic induction etc. In the mode of execution, it can be the wireless charging panel that is placed into wall surface or desktop fixed positions in which NFC coil is set.

The mobile communication of the invention has the function of low battery automatic charging. It is more convenient to use.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of realizing low battery fully automatic charging in communication equipment, including the following steps:
a) Providing a quantity of electricity detector, when quantity of electricity detector detects that the quantity of electricity of mobile communication equipment is lower than set threshold, step (b) should be started;
b) the said mobile communication equipment searching and positioning one external charging device to positioning the coordinates of mobile communication equipment by taking the position where the external charging device is placed as the origin of coordinates;
c) Starting the mobile communication terminal to move towards the direction of the external charging device;
d) providing an interface set on the mobile communication equipment; wherein charging of mobile communication equipment is realized through the matching of interface and external charging device.

2. A mobile communication equipment, including:
a housing having an internal receiving space used for receiving and protecting internal structure of the mobile communication equipment.
a mainboard and a processor fixed on the mainboard for configuring and controlling internal element;
a power supply unit, which is received in the housing, and is connected with the mainboard electrically;
a quantity of electricity detector, which is used for detecting the quantity of electricity of power supply unit, exchanging data with processor, outputting detection result of quantity of electricity to processor;
a positioning device, which exchanges data with an external charge device, positions the place where the external charging device is placed and calculates the distance to the external charging unit;
a mobile device, which is received in the housing;
a sensor, which is set on the housing, used for sensing obstacle and transmitting the sensed result to the processor to make mobile device to avoid obstacles;
an interface, which is set on housing, is connected with the power supply unit electrically.

3. The mobile communication equipment in claim 2, further including a telescopic control device and a mobile driving device.

4. The mobile communication equipment in claim 3, wherein the mobile driving device is telescopic universal roller wheel controlled by telescopic control device.

5. The mobile communication equipment in claim 3, wherein an openable window is set further on the said housing, the openable window is covered on the said receiving groove and is connected with the telescopic control device.

6. The mobile communication equipment in claim 2, wherein the interface is a NFC charge coil enclosed in the housing, and correspondingly, external charging device is a coil matching the NFC charge coil.

7. The mobile communication equipment in claim 2, wherein the sensor is infrared sensor.

8. The mobile communication equipment in claim 2, wherein the positioning device includes a first positioning device and a second positioning device, the first positioning device and the second positioning device are set on the housing at specific distance.
